(19) United States
(12) Patent Application Publication
(10) Pub. No.: US 2013/0222398 A1
(43) Pub. Date: Aug. 29, 2013

(54) GRAPHIC PROCESSING UNIT AND GRAPHIC DATA ACCESSING METHOD THEREOF

(71) Applicant: Chih-Yu LO, New Taipei City (TW)

(72) Inventor: Chih-Yu LO, New Taipei City (TW)

(21) Appl. No.: 13/461,461

(22) Filed: May 1, 2012

(30) Foreign Application Priority Data
Feb. 23, 2012 (TW) 101105920

(51) Int. Cl. G09G 5/36; G06T 1/20

(52) U.S. Cl. 345/506

(57) ABSTRACT

A graphic processing unit and a graphic data accessing method are provided. The graphic processing unit receives a graphic processing request instruction which comprises a first coordinate bits and a second coordinate bits of a under processing texel image, from the server processing unit. The graphic processing unit retrieves at least one first bit of the first coordination bits, retrieves at least one second bit of the second coordination bits, and derives a cache index from the at least one first bits and the at least one second bits via an arithmetic logic operation.

This application claims priority to Taiwan Patent Application No. 101105920 filed on Feb. 23, 2012, which is hereby incorporated by reference in its entirety.

### CROSS-REFERENCES TO RELATED APPLICATIONS

Not applicable.

### BACKGROUND OF THE INVENTION

1. Field of the Invention

The present invention provides a graphic processing unit and a graphic data accessing method thereof. More particularly, the graphic processing unit and the graphic data accessing method of the present invention use two coordinates of a pixel for calculation of a cache index and use a plurality of memory banks of a cache memory to store pixels that are highly correlated respectively.

2. Descriptions of the Related Art

In conventional computer hardware architectures, a central processing unit (CPU) is responsible for most hardware instruction operations. However, as science and technologies develop continuously, the amount of operations required by the peripheral hardware also increases correspondingly. This imposes an excessive burden on the CPU and significantly degrades the overall performance of the CPU. To solve this problem in hardware where an excessive amount of instruction operations is required, low-level processing units must be deployed to execute instruction operations separately so that the workload of the CPU can be reduced to improve the overall performance. The most common hardware where a processing unit is deployed separately is the graphic displaying hardware.

Specifically, the graphic displaying hardware (e.g., a display card) should be responsible for all operations related to image displays, and the image display is a very important part in computer operation. Therefore, to maintain the overall performance by reducing the workload of the CPU, a separate graphic processing unit is deployed in the graphic displaying hardware so that the computational burden can be shared by the graphic processing unit to remarkably improve the performance that would otherwise be degraded due to the image processing.

Graphic processing units that are commonly used at present may all be considered as low-level CPUs. In other words, the graphic processing units have a basic hardware architecture similar to that of a CPU; i.e., they also each comprise a control logic unit and a cache memory. Accordingly, although additionally using a graphic processing unit in the graphic displaying hardware can improve the overall performance, this also has a drawback similar to that of general CPUs: if the graphic processing unit cannot efficiently utilize the cache memory which has a limited memory capacity, then the overall performance will not be effectively improved or will even possibly be degraded.

In detail, like a general CPU, the performance of a graphic processing unit is determined mainly by an access hit rate of the cache memory. When the graphic processing unit accesses data from the cache memory, a high hit rate of data accessing means that the graphic processing unit can access data rapidly and efficiently; and conversely, a low hit rate of data accessing means that the graphic processing unit has to allocate additional resources to an external random access memory (RAM) for data accessing and the low reading speed of the RAM also delays the overall data reading time. Therefore, how to improve the access hit rate of the graphic processing unit with respect to the cache memory through more efficient management of the cache memory is also an important topic.

Furthermore, each storing unit in the cache memory of the graphic processing unit corresponds to an index field. Before a data is stored into a storing unit, usually an index field is selected according to a specific bit of the data and then the data is stored into the corresponding storing unit. Then, when the graphic processing unit receives instruction to access the data, the graphic processing unit selects the corresponding index field from the cache memory according to the specific bit of the data, and determines whether the data stored in the corresponding storing unit is correct. If the data stored in the corresponding storing unit is correct, the graphic processing unit can access the data from the storing unit directly.

However, the graphic processing units that are currently available use an image data to create an index and fail to effectively improve the hit rate. Specifically, because of the specificity of the coordinates of the image data, management made by the graphic processing units on cache memories is primarily accomplished by using the coordinates of a same dimension as indices. In more detail, when U-dimension (or V-dimension) coordinates are taken as a reference of the indices, Uₓ (or V_{y}) coordinates are mainly used in the prior art as a reference of indices for image data with Uₓ and V_{y} coordinates.

Herein, a case where the U-dimension coordinates are used as a reference of indices is taken as an example. When the graphic processing unit is to access the image data with coordinates (Uₓ, V_{y}) after receiving a instruction, the graphic processing unit will select indices with the same Uₓ value from the cache memory and then determine whether the data stored in each of the storing unit corresponding to these indices hits the image data with coordinates (Uₓ, V_{y}). If the image data is hit, then the image data in the cache memory is accessed directly according to the coordinates (Uₓ, V_{y}); otherwise, if the image data is missed, then the graphic processing unit has to re-access the image data with the coordinates (Uₓ, V_{y}) from the external random accessing memory, store the coordinates (Uₓ, V_{y}) into the corresponding storing unit in the cache memory and then access the image data with the coordinates (Uₓ, V_{y}).

However, in the process of creating indices of image data where the contents of adjacent coordinate points are highly correlated, the prior art of using coordinates of a single dimension as indices of the cache memory is relatively inefficient. For example, in the case where the U-dimension coordinates are used as the reference for indices, if an image data with coordinates (U₁, V₁) is already stored in the cache memory of the graphic processing unit, then when the graphic processing unit is to access the image data with the coordinates (U₁, V₂) after receiving an instruction, the graphic processing unit will select indices with the same U₁ value from the cache memory to determine the data.

However, what is stored in the storing unit corresponds to the indices with the same U₁ value in the storing unit, which is the image data with the coordinates (U₁, V₁); these coordinates are obviously different from (U₁, V₂). Consequently, a mis-reading results. Then, the graphic processing unit must re-access the image data with the coordinates (U₁, V₂) from the external RAM, store the image data with the coordinates (U₁, V₂) into the corresponding storing unit in the cache memory and then access the image data with the coordinates (U₁, V₂). It shall be particularly noted that, because the image data with the coordinates (U₁, V₂) also needs to be stored in the cache memory in the aforesaid way of using the index as a reference, the content (which is originally the image data with the coordinates (U₁, V₁)) of the storing unit that corresponds to the index identical to U₁ is now overwritten by the image data with the coordinates (U₁, V₂).

Next, if the graphic processing unit is to use the image data with the coordinates (U₁, V₁) again after receiving the next instruction, the graphic processing unit will select the index that is identical to U₁ from the cache memory to determine the data. However, the storing unit that corresponds to the index that is identical to U₁ has been overwritten by the image data with the coordinates (U₁, V₂), and another mis-reading will result again. Then, the graphic processing unit must re-access the image data with the coordinates (U₁, V₁) from the external RAM, store the image data with the coordinates (U₁, V₁) into the corresponding storing unit in the cache memory, and then access the image data with the coordinates (U₁, V₁) again. Likewise, the content (which is originally the image data with the coordinates (U₁, V₂)) of the storing unit that corresponds to the index identical to U₁ is now overwritten by the image data with the coordinates (U₁, V₁). Thus, it can be clearly known from the above descriptions that, for image data where contents of adjacent coordinate points are highly correlated, the prior art of creating and using indices is relatively inefficient.

Furthermore, when the data at a specific coordinate point of an image is processed, the rate of repeatedly using data at coordinate points adjacent to the specific coordinate point within a fixed time period will be increased because of the aforesaid specificity of the image data. However, because the management of accessing cache memories is mostly accomplished in units of blocks in the prior art, the flexibility in use of data at coordinate points adjacent to the specific coordinate point will be significantly decreased in the reading and writing processes. In detail, if the graphic processing unit, which is accessing the data at a specific coordinate point arranged in a first block, needs to use data at an adjacent coordinate point arranged in a second block, the graphic processing unit has to read all of the data of the second block in units of one block although what the graphic processing unit needs is only a part of the data (i.e., the data of the adjacent coordinate) in the second block. Obviously, the low flexibility in use of the conventional cache memories leads to a low overall operation efficiency.

Accordingly, it is important to overcome the shortcomings of the conventional graphic processing units to improve the overall performance more efficiently.

### SUMMARY OF THE INVENTION

To solve the aforesaid problems, the present invention provides a graphic processing unit and a graphic data accessing method thereof, which can utilize multi-dimension coordinates of an image data as a reference of indices of a cache memory. On the other hand, the graphic processing unit and graphic data accessing method thereof of the present invention further allow for the flexible use of cache memory by means of a plurality of memory banks and block division.

To achieve the aforesaid objectives, the present invention provides a graphic data accessing method for use in a graphic processing unit. The graphic processing unit comprises a texel image processor. The graphic processing unit is electrically connected to a server processing unit. The graphic data accessing method comprises the following steps: (a) enabling the texel image processor to receive a graphic processing request instruction from the server processing unit, wherein the graphic processing request instruction comprises first coordinate bits and second coordinate bits of a under processing texel image; (b) enabling the texel image processor to retrieve at least one first index bit of the first coordinate bits, and to retrieve at least one second index bit of the second coordinate bits; and (c) enabling the texel image processor to derive a cache index from the at least one first index bit and the at least one second index bit via an arithmetic logic operation.

On the other hand, the graphic processing unit further comprises a graphic data processor, a graphic cache memory, a cache memory manager, an external memory accessor and a texel image block divider. The graphic processing unit is further electrically connected to a random access memory. The graphic data accessing method further comprises the following steps: (d) enabling the cache memory manager to select an index field from an index register of the graphic cache memory according to the cache index; (e) enabling the cache memory manager to determine that the first coordinate bits and the second coordinate bits miss a tag content corresponding to the index field of the index register; (f) enabling the external memory accessor to read from the random access memory an image data of the under processing texel image corresponding to the first coordinate bits and the second coordinate bits based on the graphic processing request instruction after step (e); (g) enabling the texel image block divider to divide the image data of the under processing texel image into a plurality of data blocks, and to store the plurality of data blocks into a plurality of data storing the addresses of the graphic cache memory; (h) enabling the cache memory manager to record the corresponding relation between the plurality of data storing addresses and the tag content; and (i) enabling the graphic data processor to access and process the image data of the under processing texel image stored in the plurality of data storing addresses after the step (h).

To achieve the aforesaid objectives, the present invention further provides a graphic processing unit, which is electrically connected to a server processing unit. The graphic processing unit comprises a texel image processor. The texel image processor receives a graphic processing request instruction from the server processing unit. The graphic processing request instruction comprises first coordinate bits and second coordinate bits of a under processing texel image. The texel image processor further retrieves at least one first index bit of the first coordinate bits and retrieves at least one second index bit of the second coordinate bits, and derives a cache index from the at least one first index bit and the at least one second index bit via an arithmetic logic operation.

On the other hand, the graphic processing unit further comprises a graphic data processor; a graphic cache memory; a cache memory manager; an external accessor; and a texel image black divider. The cache memory manager selects an index field from an index register of the graphic cache memory according to the cache index and determines that the first coordinate bits and the second coordinate bits miss a tag content corresponding to the index field of the index register. The external memory accessor reads from the random access memory an image data of the under processing texel image corresponding to the first coordinate bits and the second coordinate bits based on the graphic processing request instruction. The texel image block divider divides the image data of the under processing texel image into a plurality of data blocks and stores the plurality of data blocks into a plurality of data storing the addresses of the graphic cache memory. The cache memory manager further records a corresponding relation between the plurality of data storing addresses and the tag content. The graphic data processor further accesses and processes the image data of the under processing texel image that is stored in the plurality of data storing addresses.

According to the above descriptions, the graphic processing unit and the graphic data accessing method thereof of the present invention can utilize the result of performing an arithmetic logic operation on the multi-dimension coordinates of an image data as a reference of indices of a cache memory, and further allow for a highly flexible use of the cache memory by means of a plurality of memory banks and block division to significantly improve the utilization efficiency of the cache memory.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a graphic processing unit according to the first embodiment of the present invention;

FIG. 1B is a schematic view illustrating calculation of indices in the first embodiment of the present invention;

FIG. 2A is a schematic view of a graphic processing unit according to the second embodiment of the present invention;

FIG. 2B is a schematic view illustrating an index hit status in the second embodiment of the present invention;

FIG. 2C is a schematic view illustrating how the texel image block divider divides an image data according to the second embodiment of the present invention;

FIG. 3 is a flowchart diagram of a graphic data accessing method according to the third embodiment of the present invention;

FIG. 4A is a flowchart diagram of a graphic data accessing method according to the fourth embodiment of the present invention; and

FIG. 4B is also a flowchart diagram of a graphic data accessing method according to the fourth embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, the description of these embodiments is only for the purpose of illustration rather than limitation. It should be appreciated that in the following embodiments and attached drawings, elements unrelated to the present invention are omitted from depiction.

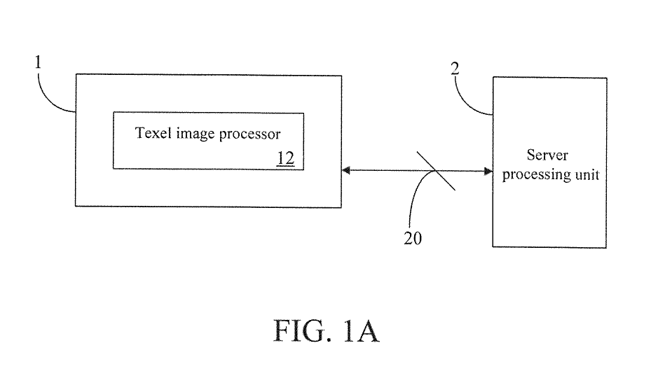

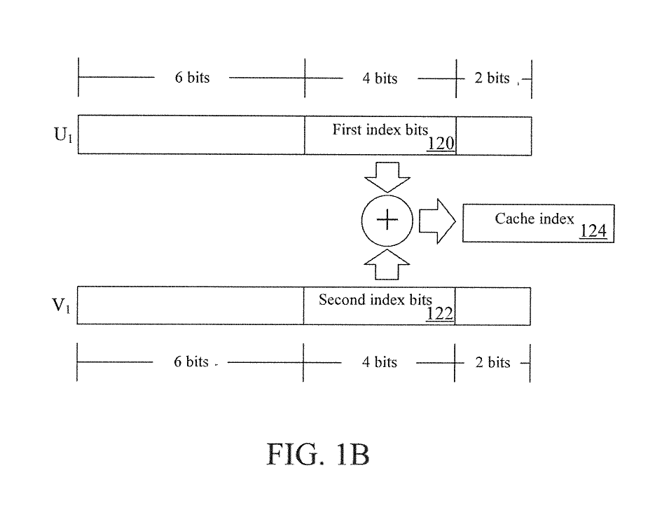

FIG. 1A illustrates the schematic view of a graphic processing unit 1 according to the first embodiment of the present invention. The graphic processing unit 1 comprises a texel image processor 12 and is electrically connected to a server processing unit 2. Interactions among the individual components will be further described hereinafter.

Similar to general processing units, the graphic processing unit will interpret contents of the received instruction to carry out subsequent operations. Specifically, in the first embodiment, the texel image processor 12 of the graphic processing unit 1 receives a graphic processing request instruction 20 from the server processing unit 2. The graphic processing request instruction 20 comprises first coordinate bits U₁ and second coordinate bits V₁ of a under processing texel image.

After receiving the instruction, the graphic processing unit retrieves a part of the contents of the instruction as an index and accesses data from a cache memory according to the index. FIG. 1B illustrates the schematic view of the calculation of indices in the first embodiment of the present invention. In detail, the texel image processor 12 retrieves at least one first index bit 120 of the first coordinate bits U₁, and retrieves at least one second index bit 122 of the second coordinate bits V₁.

It shall be particularly appreciated that the bits retrieved in the first embodiment are bits No. 7 to No. 10 of the coordinate bits as shown in FIG. 1B; however, this is not intended to limit the present invention, and other possible ways of retrieving bits may be readily determined by those skilled in the art. The main technical feature of the present invention is that the bits of two coordinate values are retrieved simultaneously for use as a reference of indices.

Then, the texel image processor 12 performs an arithmetic logic operation on the at least one first index bit 120 and the at least one second index bit 122 to derive a cache index 124. It shall be particularly emphasized that, the cache index 124 is derived mainly by performing an “OR” arithmetic logic operation in the first embodiment; however, this is not intended to limit the arithmetic logic operation adopted in the present invention, and those skilled in the art may also calculate the cache index through other arithmetic logic operations such as an “AND” arithmetic logic operation.

Thus, in the way described in the first embodiment, the graphic processing unit of the present invention can utilize the result of performing an arithmetic logic operation on the two-dimension coordinates of an image data to search for an index so that it can be subsequently determined whether the data access corresponding to the index is correct.

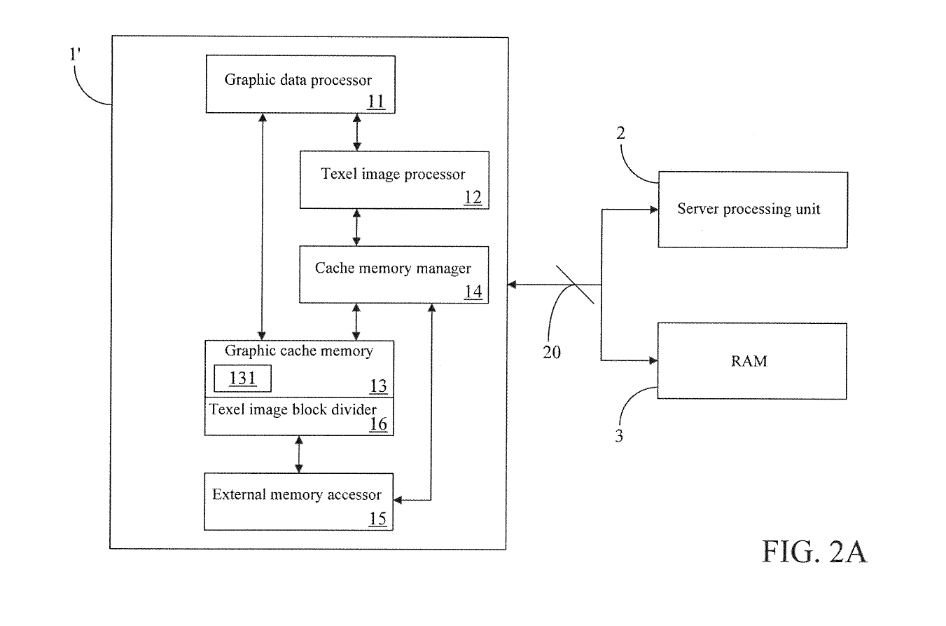

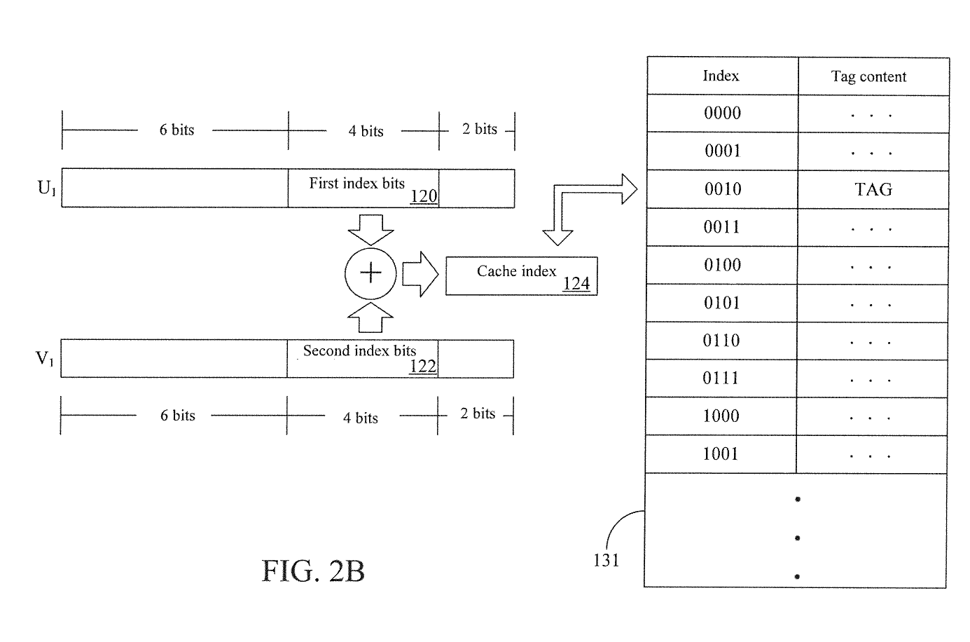

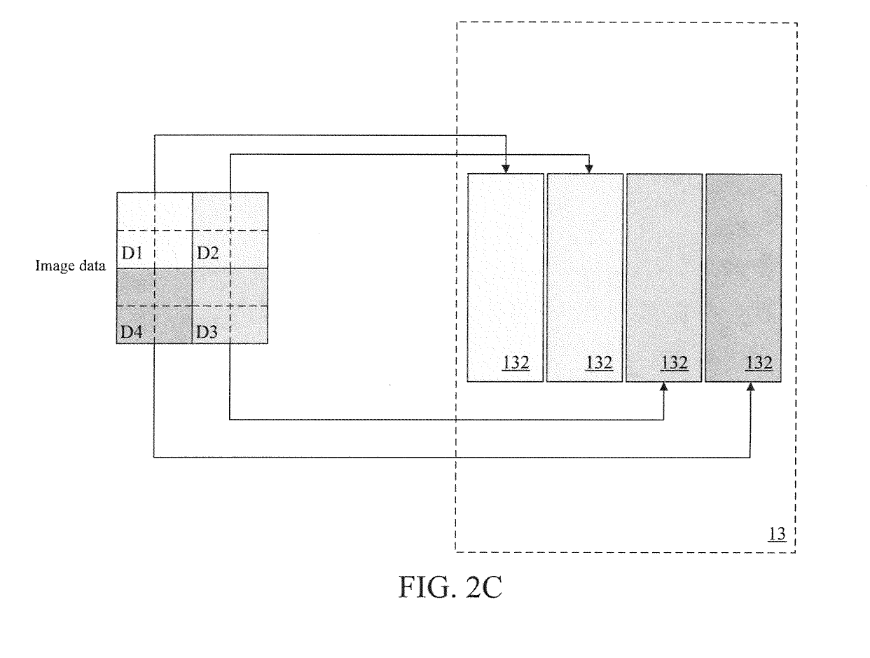

FIG. 2A illustrates the schematic view of a graphic processing unit 1′ according to the second embodiment of the present invention. The graphic processing unit 1′ further comprises a graphic data processor 11, a graphic cache memory 13, a cache memory manager 14, an external memory accessor 15 and a texel image block divider 16. The graphic cache memory 13 further comprises an index register 131. It shall be particularly noted that, the components bearing the same reference numerals as those of the first embodiment have the same functions in the second embodiment, so they will not be further described herein. Instead, the second embodiment will focus on the operations subsequent to the hit or miss of data in the graphic cache memory.

FIG. 2B illustrates the schematic view of an index hit status in the second embodiment of the present invention. Furthermore, before the graphic data processor 11 accesses the image data of the under processing texel image from the graphic cache memory 13 in the aforesaid manner, the cache memory manager 14 must first determine whether the data is hit or missed.

If it is presumed that the calculation result of the cache index 124 is “0010” in the second embodiment, then the cache memory manager 14 selects from the graphic cache memory 13 an index field with an index of “0010”, and then determines whether the first coordinate bits U₁ and the second coordinate bits V₁ hit or miss a tag content TAG corresponding to this index field with the index of “0010” of the index register 131.

If the cache memory manager 14 determines that the first coordinate bits U₁ and the second coordinate bits V₁ hit the tag content TAG corresponding to this index field with the index of “0010” of the index register 131, it means that the data requested by the graphic processing request instruction 20 has been stored in the graphic cache memory 13. In this case, the graphic data processor 11 accesses and processes the image data of the under processing texel image that is stored in a plurality of data storing addresses according to the corresponding relation between the tag content TAG and the data storing addresses (not shown) of the graphic cache memory 13.

On the other hand, if the cache memory manager 14 determines that the first coordinate bits U₁ and the second coordinate bits V₁ miss the tag content TAG corresponding to this index field with the index of “0010” of the index register 131, it means that the data requested by the graphic processing request instruction 20 is not stored in the graphic cache memory 13. In other words, the data is still only stored in an external memory. In this case, the external memory accessor 15 reads, from the RAM 3, the image data of the under processing texel image that corresponds to the first coordinate bits U₁ and the second coordinate bits V₁ according to the graphic processing request instruction 20.

Then, the image data must be firstly stored in the cache memory, and the relation between the storing addresses of the image data in the cache memory and the index register is recorded for subsequent use in data accessing. Specifically, the texel image block divider 16 divides the image data of the under processing texel image into a plurality of data blocks, and stores the plurality of data blocks into a plurality of data storing addresses of the graphic cache memory 13. Subsequently, the corresponding relation between the data storing addresses and the tag content TAG corresponding to the index field with the index of “0010” is recorded by the cache memory manager 14.

Thus, after the corresponding relation is recorded, the graphic data processor 11 can access and process the image data of the under processing texel image stored in the data storing addresses according to the corresponding relation. It shall be particularly appreciated that, the corresponding relation between the index of the index register, the tag content and the data storing addresses described above are just a conventional cache memory technology, so it will not be further described herein. The second embodiment of the present invention focuses on the way of data accessing subsequent to hit or miss of the cache memory after the index comparison.

Next, the image data is stored in the cache memory in blocks that will be further detailed. FIG. 2C illustrates the schematic view of how the texel image block divider 16 divides an image data in the second embodiment of the present invention. Here, the graphic cache memory 13 of the present invention further comprises a plurality of memory banks 132 for sequentially storing the image data that has been divided into blocks.

Specifically, after the external memory accessor 15 reads, from the RAM 3, the image data of the under processing texel image that corresponds to the first coordinate bits U₁ and the second coordinate bits V₁, the texel image block divider 16 divides the image data of the under processing texel image into data blocks D1˜D4 and stores the data blocks sequentially into data storing addresses of the graphic cache memory 13. Here, the data storing addresses correspond to the memory banks 132; that is, the data blocks D1˜D4 are sequentially stored into a plurality of memory banks 132.

Thus, the present invention allows for accessing the image data in a flexible way by storing the image data in blocks as described in the second embodiment. Because this can improve the efficiency of accessing data at coordinate points adjacent to the particular coordinate point, the problem with the prior art in which the reading and writing of image data in the units of a fixed block size leads to a low efficiency.

It shall be particularly appreciated that in order for the divided blocks of the image data to be completely stored, an amount of the data blocks shall be equal to the amount of the memory banks 132 and be a power of 2. In the second embodiment of the present invention, the amount of the data blocks and the amount of the memory banks 132 are both four; however, this is not intended to limit the present invention, and upon reviewing the above descriptions, those skilled in the art will readily appreciate the method in modifying the amount of divided data blocks to make it equal to the amount of memory banks of any cache memory.

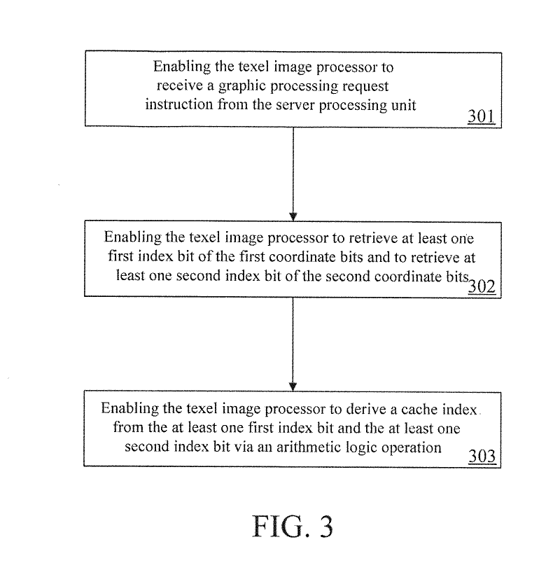

FIG. 3 is a flowchart diagram of a graphic data accessing method according to the third embodiment of the present invention. The graphic data accessing method of the third embodiment is for use in a graphic processing unit (e.g., the graphic processing unit described in the first embodiment). The graphic processing unit comprises a texel image processor and is electrically connected to a server processing unit. The steps of accessing graphic data of the third embodiment will be detailed as follows.

First, step 301 is executed to enable the texel image processor to receive a graphic processing request instruction from the server processing unit. The graphic processing request instruction comprises the first coordinate bits and the second coordinate bits of a under processing texel image. Then, step 302 is executed to enable the texel image processor to retrieve at least one first index bit of the first coordinate bits and to retrieve at least one second index bit of the second coordinate bits.

Finally, step 303 is executed to enable the texel image processor to derive a cache index from the at least one first index bit and the at least one second index bit via an arithmetic logic operation. Thus, the graphic data processing method of the present invention can utilize the result of performing an arithmetic logic operation on two-dimensional coordinates of the image data to search for an index so that it can be subsequently determined whether the data access corresponding to the index is correct.

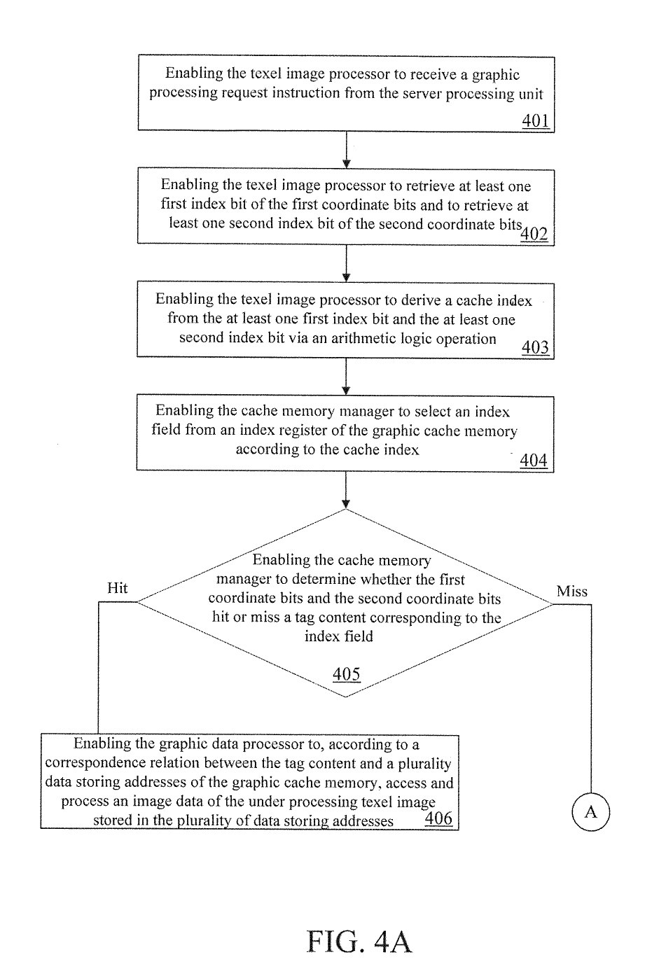

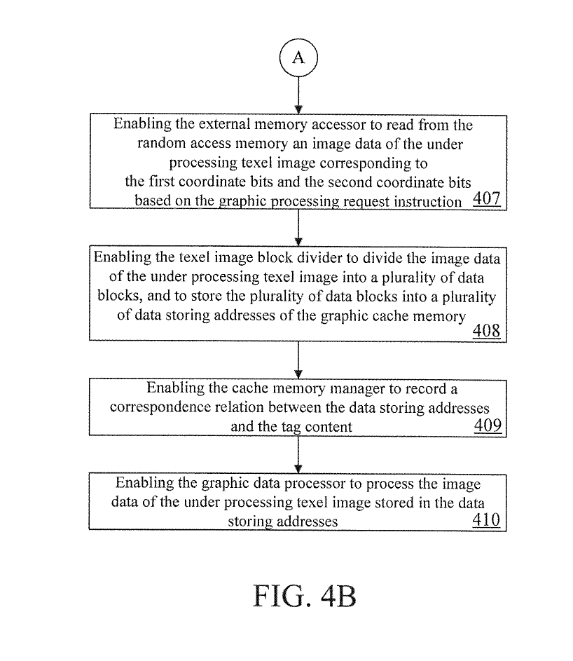

FIGS. 4A and 4B illustrates the flowchart diagrams of a graphic data processing method according to the fourth embodiment of the present invention. The graphic data processing method of the fourth embodiment is also for use in a graphic processing unit (e.g., the graphic processing unit described in the second embodiment). The graphic processing unit comprises a texel image processor, a graphic data processor, a graphic cache memory, a cache memory manager and an external memory accessor, and is electrically connected to a server processing unit and an RAM. Steps of accessing the graphic data of the fourth embodiment will be detailed as follows.

First, step 401 is executed to enable the texel image processor to receive a graphic processing request instruction from the server processing unit. The graphic processing request instruction comprises the first and second coordinate bits of a under processing texel image. Then, step 402 is executed to enable the texel image processor to retrieve at least one first index bit of the first coordinate bits and to retrieve at least one second index bit of the second coordinate bits.

Next, step 403 is executed to enable the texel image processor to derive a cache index from the at least one first index bit and the at least one second index bit via an arithmetic logic operation. Step 404 is executed to enable the cache memory manager to select an index field from an index register of the graphic cache memory according to the cache index. Then, step 405 is executed to enable the cache memory manager to determine whether the first coordinate bits and the second coordinate bits hit or miss a tag content corresponding to the index field of the index register.

If the first coordinate bits and the second coordinate bits hit the tag content, then step 406 is executed to enable the graphic data processor to, according to the corresponding relation between the tag content and a plurality data storing addresses of the graphic cache memory, access and process the image data of the under processing texel image that is stored in the plurality of data storing addresses. Otherwise, if the first coordinate bits and the second coordinate bits miss the tag content, then step 407 is executed to enable the external memory accessor to read, from the random access memory, an image data of the under processing texel image that corresponds to the first coordinate bits and the second coordinate bits based on the graphic processing request instruction.

Afterwards, step 408 is executed to enable the texel image block divider to divide the image data of the under processing texel image into a plurality of data blocks, and to store the plurality of data blocks into a plurality of data storing addresses of the graphic cache memory. Step 409 is executed to enable the cache memory manager to record a corresponding relation between the plurality of data storing addresses and the tag content. Finally, step 410 is executed to enable the graphic data processor to access and process the image data of the under processing texel image stored in the plurality of data storing addresses.

It shall be particularly appreciated that the data blocks may be further stored by the texel image block divider into memory banks corresponding to the data storing addresses sequentially in the step 408. Herein, an amount of the data blocks is equal to that of the memory banks and is a power of 2.

According to the above descriptions, the graphic processing unit and the graphic data accessing method thereof of the present invention can utilize the result of performing an arithmetic logic operation on the two-dimensional coordinates of an image data as a reference of indices of a cache memory, and further allow for the highly flexible use of the cache memory by means of a plurality of memory banks and block division. Thereby, the utilization efficiency of the cache memory is significantly improved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A graphic data accessing method for use in a graphic processing unit, the graphic processing unit comprising a texel image processor, the graphic processing unit being electrically connected to a server processing unit, the graphic data accessing method comprising the following steps:
(a) enabling the texel image processor to receive a graphic processing request instruction from the server processing unit, wherein the graphic processing request instruction comprises first coordinate bits and second coordinate bits of a under processing texel image;
(b) enabling the texel image processor to retrieve at least one first index bit of the first coordinate bits, and to retrieve at least one second index bit of the second coordinate bits; and
(c) enabling the texel image processor to derive a cache index from at least one first index bit and at least one second index bit via an arithmetic logic operation.

2. The graphic data accessing method as claimed in claim 1, wherein the graphic processing unit further comprises a graphic data processor, a graphic cache memory and a cache memory manager, and the graphic data accessing method further comprises the following steps:
(d) enabling the cache memory manager to select an index field from an index register of the graphic cache memory according to the cache index;
(e) enabling the cache memory manager to determine that the first coordinate bits and the second coordinate bits hit a tag content corresponding to the index field of the index register; and
(f) enabling the graphic data processor, according to a corresponding relation between the tag content and a plurality data storing addresses of the graphic cache memory, access and process an image data of the under processing texel image stored in the plurality of data storing addresses after the step (e).

3. The graphic data accessing method as claimed in claim 1, wherein the graphic processing unit further comprises a graphic data processor, a graphic cache memory, a cache memory manager, an external memory accessor and a texel image block divider, the graphic processing unit is further electrically connected to a random accessing memory, and the graphic data accessing method further comprises the following steps:
(d) enabling the cache memory manager to select an index field from an index register of the graphic cache memory according to the cache index;
(e) enabling the cache memory manager to determine that the first coordinate bits and the second coordinate bits miss a tag content corresponding to the index field of the index register;
(f) enabling the external memory accessor to read from the random access memory an image data of the under processing texel image corresponding to the first coordinate bits and the second coordinate bits based on the graphic processing request instruction after the step (e);
(g) enabling the texel image block divider to divide the image data of the under processing texel image into a plurality of data blocks, and to store the plurality of data blocks into a plurality of data storing addresses of the graphic cache memory;
(h) enabling the cache memory manager to record a corresponding relation between the plurality of data storing addresses and the tag content; and
(i) enabling the graphic data processor to access and process the image data of the under processing texel image stored in the plurality of data storing addresses after the step (h).

4. The graphic data accessing method as claimed in claim 3, wherein the plurality of the data storing addresses correspond to a plurality of memory banks of the graphic cache memory, and the step (g) further comprises the following step:
(g1) enabling the texel image block divider to store the plurality of data blocks into the plurality of memory banks corresponding to the plurality of the data storing addresses in order, wherein an amount of the plurality of data blocks is equal to an amount of the plurality of memory banks, and the amounts are a power of 2.

5. A graphic processing unit, which is electrically connected to a server processing unit, comprising:
a texel image processor;
wherein the texel image processor receives a graphic processing request instruction from the server processing unit, the graphic processing request instruction comprises first coordinate bits and second coordinate bits of a under processing texel image, the texel image processor further retrieves at least one first index bit of the first coordinate bits and retrieves at least one second index bit of the second coordinate bits, and the texel image processor derives a cache index from at least one first index bit and at least one second index bit via an arithmetic logic operation.

6. The graphic processing unit as claimed in claim 5, further comprising:
a graphic data processor;
a graphic cache memory; and
a cache memory manager,
wherein the cache memory manager selects an index field from an index register of the graphic cache memory according to the cache index and determines that the first coordinate bits and the second coordinate bits hit a tag content corresponding to the index field of the index register, and the graphic data processor accesses and processes an image data of the under processing texel image stored in a plurality of data storing addresses of the graphic cache memory according to a corresponding relation between the tag content and the plurality of data storing addresses.

7. The graphic processing unit as claimed in claim 5, being further electrically connected to a random accessing memory, wherein the graphic processing unit further comprises:
a graphic data processor;
a graphic cache memory;
a cache memory manager;
an external accessor; and
a texel image black divider,
wherein the cache memory manager selects an index field from an index register of the graphic cache memory according to the cache index and determines that the first coordinate bits and the second coordinate bits miss a tag content corresponding to the index field of the index register, the external memory accessor reads, from the random access memory, an image data of the under processing texel image corresponding to the first coordinate bits and the second coordinate bits based on the graphic processing request instruction, the texel image block divider divides the image data of under processing the texel image into a plurality of data blocks and stores the plurality of data blocks into a plurality of data storing addresses of the graphic cache memory, the cache memory manager further records a corresponding relation between the plurality of data storing addresses and the tag content, and the graphic data processor further accesses and processes the image data of the under processing texel image stored in the plurality of data storing addresses.

8. The graphic processing unit as claimed in claim 7, wherein the plurality of data storing addresses correspond to a plurality of memory banks of the graphic cache memory, the texel image block divider further stores the plurality of data blocks into the plurality of memory banks corresponding to the plurality of the data storing addresses in order, and an amount of the plurality of data blocks is equal to an amount of the plurality of the memory banks, and the amounts are a power of 2.
